(19) United States
(12) Patent Application Publication
(10) Pub. No.: US 2026/0060503 A1
(43) Pub. Date: Mar. 5, 2026

(54) MOISTURE-REMOVAL APPARATUS FOR REMOVING MOISTURE FROM A MOP-HEAD COVER OF A CLEANING APPLIANCE

(71) Applicant: Carl Freudenberg KG, Weinheim (DE)

(72) Inventor: Marc HEILAND, Worms (DE)

(21) Appl. No.: 19/300,713

(22) Filed: Aug. 15, 2025

(30) Foreign Application Priority Data
Aug. 27, 2024 (DE) 10 2024 124 409.7

(51) Int. Cl. A47L 13/59; A47L 13/254

(52) U.S. Cl. CPC A47L 13/59; A47L 13/254

(57) ABSTRACT

A moisture-removal apparatus for removing moisture from a mop-head cover on a support plate of a cleaning appliance includes a frame with a squeezing-out gap, into which the support plate including the mop-head cover can be inserted. The moisture-removal apparatus also includes a stripping device, which is arranged to a side of the squeezing-out gap and includes a stripper for stripping liquid from the mop-head cover, where a sleeve guide is provided for holding and guiding the stripping device on the frame for the stripper to be displaced linearly back and forth via the sleeve guide between a squeezing-out position and a position. The sleeve guide includes at least one sleeve with an opening and at least one guide pin which can be inserted through the opening and is mounted for sliding action in the sleeve.

### CROSS REFERENCE TO RELATED APPLICATIONS

This application claims benefit to German Patent Application No. DE 10 2024 124 409.7, filed on Aug. 27, 2024, which is hereby incorporated by reference herein.

### FIELD

The invention relates to a moisture-removal apparatus for removing moisture from a mop-head cover on a support plate of a cleaning appliance.

### BACKGROUND

EP 3 446 613 B1 discloses a cleaning system which comprises a cleaning appliance and a bucket with a cleaning apparatus and moisture-removal apparatus for the cleaning appliance. The cleaning appliance is a flat mop having a support plate, a mop-head cover fitted thereon, and a handle, which is connected to the support plate via a Cardan joint. The cleaning apparatus and the moisture-removal apparatus are in the form of separate units. The moisture-removal apparatus is mounted on the bucket and has a squeezing-out gap, in which a stripper is mounted in a displaceable manner. For this purpose, the stripper is guided in laterally arranged, inclined guide grooves. The inclination is such that, when it is moved downward, the stripper narrows the squeezing-out gap and, when it is moved upward, the stripper widens the squeezing-out gap.

For squeezing-out purposes, the support plate of the flat mop including the mop-head cover is rotated into a vertical position parallel to the handle and initially inserted into the squeezing-out gap by way of the narrow side. In the process, the linearly displaceably mounted stripper is pushed downward, by way of the mop-head cover, into the horizontal squeezing-out position and narrows the squeezing-out gap. The mop-head cover here is guided along the stripper in the gap and has the liquid removed from it by stripping. When it is withdrawn from the gap, the stripper, on account of the frictional force generated by the mop-head cover, is carried along upward and moved into a position which widens the squeezing-out gap and is located above the squeezing-out position. This makes it easier for the flat mop to be withdrawn and prevents the bucket from being pulled along upward and lifting off the ground. When the flat mop is next inserted, the stripper is pushed downward again in the direction of the squeezing-out position or it moves of its own accord back into the squeezing-out position on account of gravitational force.

A disadvantage of the known moisture-removal apparatus is that, when the liquid is being stripped from the mop-head cover, in particular in the case of dirty water, liquid penetrates into the entire arrangement made up of the stripper and holder for the stripper in the frame. In particular, it is also possible for dirty water to escape through the lateral guide grooves and to contaminate the lateral outer wall of the moisture-removal apparatus in the region of the guide of the stripper with its grooves and edges.

A commercially available cleaning system similar to the one described above has a sleeve guide provided between the stripping device and frame, it being possible for the stripper to be displaced linearly back and forth at an angle of inclination by means of the sleeve guide between the squeezing-out position, which narrows the squeezing-out gap, and the position which widens the squeezing-out gap. The guide here has a sleeve with an opening and also has a guide pin, which can be inserted through the opening, is mounted for sliding action in the sleeve and on which the stripper is fastened. It is also the case with this cleaning system that dirty water can also pass in particular into the sleeve.

### SUMMARY

In an embodiment, the present disclosure provides a moisture-removal apparatus for removing moisture from a mop-head cover on a support plate of a cleaning appliance that includes a frame with a squeezing-out gap, into which the support plate including the mop-head cover can be inserted. The moisture-removal apparatus also includes a stripping device, which is arranged to a side of the squeezing-out gap and includes a stripper for stripping liquid from the mop-head cover, where a sleeve guide is provided for holding and guiding the at least one stripping device on the frame for the stripper to be displaced linearly back and forth via the sleeve guide between a squeezing-out position, which narrows the squeezing-out gap, and a position which widens the squeezing-out gap. The sleeve guide includes at least one sleeve with an opening, and at least one guide pin which can be inserted through the opening and is mounted for sliding action in the at least one sleeve, where the stripper is arranged relative to the opening in the sleeve such that, when liquid is being stripped from the mop-head cover, none of the liquid passes into the opening.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a prior-art cleaning system comprising a cleaning container with a cleaning region and a moisture-removal region, and a flat mop with a mop-head cover, as moisture is being removed from the mop-head cover;

FIG. 2 shows a perspective illustration, as seen obliquely from above, of a moisture-removal apparatus according to an exemplary embodiment of the present disclosure with a stripping device moved part of the way upward;

FIG. 3 shows, in the same illustration as FIG. 1, the moisture-removal apparatus with the stripping device moved inward; and

FIG. 4 shows a perspective illustration, as seen obliquely from beneath, of the stripping device according to the embodiments from FIGS. 1 and 2.

### DETAILED DESCRIPTION

Embodiments of the present disclosure provide for a moisture-removal apparatus that solves problems where the moisture-removal apparatus is contaminated with dirty water in the region of the outer wall and of the guide elements.

A moisture-removal apparatus according to the present disclosure for removing moisture from a mop-head cover on a support plate of a cleaning appliance comprises a frame with a squeezing-out gap, into which the support plate including the mop-head cover can be inserted, and also comprises at least one stripping device, which is arranged to the side of the squeezing-out gap and has a stripper for stripping liquid from the mop-head cover, wherein a sleeve guide is provided for holding and guiding the stripping device on the frame, it being possible for the stripper to be displaced linearly back and forth by means of the sleeve guide between a squeezing-out position, which narrows the squeezing-out gap, and a position which widens the squeezing-out gap. The sleeve guide comprises at least one sleeve with an opening and also comprises at least one guide pin, which is mounted for sliding action in the sleeve. According to embodiments of the present disclosure, in the squeezing-out position, the stripper is arranged relative to the opening in the sleeve such that, when liquid is being stripped from the mop-head cover, none of the liquid can pass into the opening.

According to an embodiment of the present disclosure, in the squeezing-out position, the stripper is arranged beneath the opening in the at least one sleeve, as seen in relation to the vertical.

It has surprisingly been found that even just this simple measure can prevent the sleeve guide and the components located therebeneath from being contaminated with dirty water.

According to an embodiment of the present disclosure, the sleeve guide comprises two adjacent sleeves and associated guide pins for supporting and guiding the stripping device. This measure means that there is a considerably reduced risk of the stripping device tilting when the support plate including the mop-head cover is being inserted and withdrawn.

Sleeves and pins are inclined, in a manner known per se, relative to the vertical in such a manner that linear movement of the stripper results in the above-described narrowing and/or widening of the squeezing-out gap.

It is preferably the case that the sleeves are arranged on the frame and the guide pins are arranged on the stripping device. This has the advantage that the stripping device can easily be fitted into the sleeves from above by way of the guide pins.

The geometry of the sleeves and of the guide pins can be selected as desired. All that is required is for the cross sections of the sleeve openings and of the guide pins to be coordinated with one another such that the guide pins can slide in the sleeves without tilting.

The stripping device comprises at least one stripper. The stripper is preferably in the form of a rectangular plate with a stripping edge on the side facing the squeezing-out gap. The stripping device preferably also comprises a covering element, which is connected to the stripper and covers the region above the openings in the sleeves. It has proven advantageous here if the guide pins act on the covering element and the stripper is secured on that side of the covering element which faces the squeezing-out gap, and extends from there into the squeezing-out gap. In this exemplary embodiment, the guide pins move both the stripper and the covering element. The covering element here is preferably dimensioned such that it covers the entire region of the sleeve guide in the upward direction, so that liquid dripping off for example from the mop-head cover cannot drip into the sleeve guide.

In this exemplary embodiment, the covering element at the same time constitutes a stop for the downward movement of the stripper into the squeezing-out gap. The downward movement is delimited by the covering element coming to rest on the upper ends of the sleeves. The geometry and the dimensions are selected here such that, when the covering element comes to rest on the upper ends of the sleeves, the stripper is located in the squeezing-out position. The stripper and the covering element can be arranged one beside the other for example in the same plane. This means, however, that the situation where dirty water runs beneath the covering element and penetrates into the sleeves when liquid is being stripped from the mop-head cover in the squeezing-out position cannot be reliably prevented.

The stripper is therefore preferably offset downward relative to the covering element, so that, when the covering element comes to rest and the stripper reaches its squeezing-out position, the latter is located beneath the openings in the sleeves. This means that, when the liquid is being stripped from the mop-head cover, penetration of dirty water into the sleeves is reliably avoided.

The stripper, the covering element and the guide pins are preferably made in one piece from the same material.

According to an embodiment of the present disclosure, the covering element and the stripper have a downwardly extending drip-off edge on the outer periphery.

The drip-off edge prevents the dirty water from making its way around the periphery of the covering element and of the stripper and thus being able to drip into the region of the sleeve guide, and in particular into the openings in the sleeves, and contaminate the same. The dirty water drips vertically downward along the drip-off edges, for example into a chamber provided for this purpose in a bucket. Drip-off edges are known per se. A suitable geometry and suitable dimensions can easily be determined without a person skilled in the art having to exercise inventive skill.

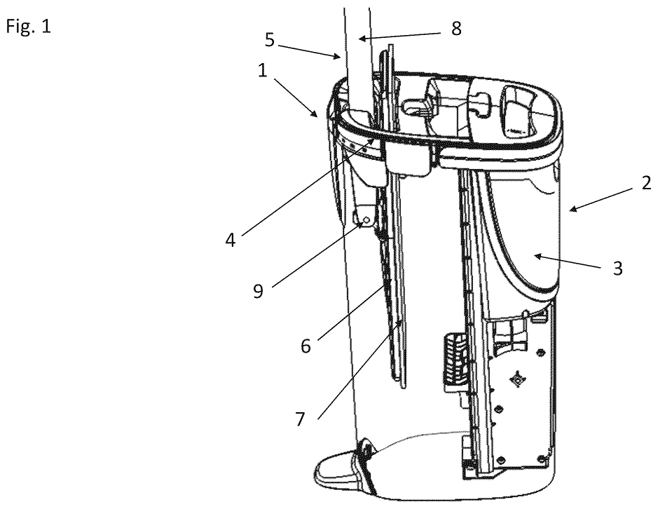

FIG. 1 shows by way of example, without loss of generality, a prior-art cleaning system 1 in which use is made of a moisture-removal apparatus according to the present disclosure. The cleaning system 1 illustrated has a cleaning container 2. Visible within that the cleaning container 2, by way of example, are a cleaning region 3 (not described in any more detail here) and a moisture-removal apparatus 4. A flat mop 5 having a support plate 6 and a mop-head cover 7 for liquid-stripping purposes have been inserted in the moisture-removal apparatus 4. Also visible are the handle 8 of the flat mop and the Cardan joint 9.

The moisture-removal apparatus 4 can be a moisture-removal apparatus according to the present disclosure. This can easily be placed on the cleaning container 2 and secured there for example by latching means.

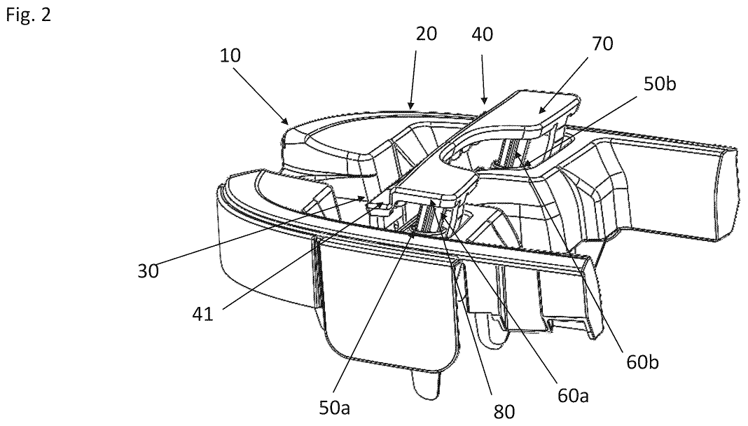

FIG. 2 shows a moisture-removal apparatus 10 according to an embodiment of the present disclosure. The moisture-removal apparatus 10 illustrated has a frame 20 with a squeezing-out gap 30, into which, as shown in FIG. 1, a support plate including a mop-head cover can be inserted from above. The squeezing-out gap 30 contains within it, without loss of generality, a stripping device 40, which is arranged to the side of the squeezing-out gap 30 and has a stripper 41 for stripping liquid from the mop-head cover, and also a covering element 70. The stripper 41 is arranged to the side of the covering element 70 and, according to an embodiment of the present disclosure, is offset downward relative to the covering element. The stripper 41 projects laterally into the squeezing-out gap 30. Arranged on the underside of the covering element 70 are two guide pins 60a, 60b, which support the covering element 70 including the stripper 41 and move up and down together. The guide pins 60a, 60b are mounted for sliding action in associated sleeves 50a, 50b. It can be seen that the sleeves are inclined in relation to the vertical in such a manner that, during the downward movement, the stripper 41 narrows the squeezing-out gap and, during the upward movement, it widens the same.

According to an exemplary embodiment of the present disclosure, the covering element 70 and the stripper 41 of the embodiment illustrated have a downwardly extending drip-off edge 80 running around their outer periphery. This prevents dirty water which comes into contact with the covering element 70 or the stripper 41 from making its way around the outer periphery and thus being able to pass into the openings in the sleeves 50a, 50b and contaminate the same.

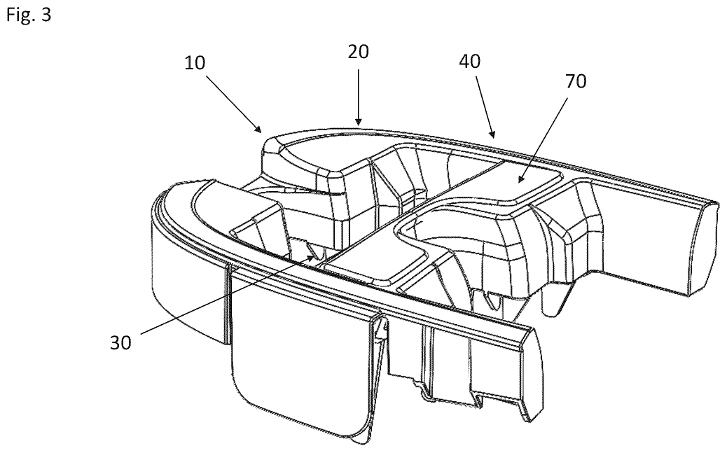

FIG. 3 shows the moisture-removal apparatus from FIG. 2 with the stripping device 40 moved inward. The same parts are denoted by the same reference signs as in FIG. 2. It can be seen that the covering element 70 covers the region of the sleeve guide in the upward direction.

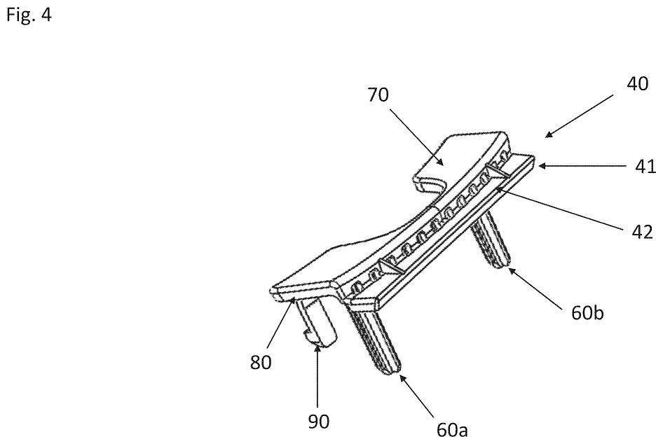

FIG. 4 shows a perspective illustration of the stripping device 40 according to the present disclosure. The stripping device 40 has a stripper 41, which is in the form of a rectangular plate with a stripping edge 42, and also a covering element 70. The guide pins 60a, 60b are arranged on the underside of the covering element 70. It is also possible to see optional guide elements 90 which have upward-movement limitation and act on the frame. Also visible is the drip-off edge 80, which is arranged on the outer periphery of the stripping device 40.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A moisture-removal apparatus for removing moisture from a mop-head cover on a support plate of a cleaning appliance, comprising:
a frame with a squeezing-out gap, into which the support plate including the mop-head cover can be inserted; and
at least one stripping device, which is arranged to a side of the squeezing-out gap and includes a stripper for stripping liquid from the mop-head cover, wherein a sleeve guide is provided for holding and guiding the at least one stripping device on the frame for the stripper to be displaced linearly back and forth via the sleeve guide between a squeezing-out position, which narrows the squeezing-out gap, and a position which widens the squeezing-out gap, and
wherein the sleeve guide comprises:
at least one sleeve with an opening; and
at least one guide pin which can be inserted through the opening and is mounted for sliding action in the at least one sleeve, wherein the stripper is arranged relative to the opening in the sleeve such that, when liquid is being stripped from the mop-head cover, none of the liquid passes into the opening.

2. The moisture-removal apparatus as claimed in claim 1, wherein in the squeezing-out position, the stripper is arranged beneath the opening in the at least one sleeve.

3. The moisture-removal apparatus as claimed in claim 1, wherein the sleeve guide comprises two sleeves and associated guide pins.

4. The moisture-removal apparatus as claimed in claim 3, wherein the two sleeves are assigned to the frame and the associated guide pins are assigned to the at least one stripping device.

5. The moisture-removal apparatus as claimed in claim 1, wherein the stripping device comprises a covering element.

6. The moisture-removal apparatus as claimed in claim 5, wherein the stripper and the covering element have a downwardly extending drip-off edge running around their outer periphery.
